(19) United States
(12) Patent Application Publication
(10) Pub. No.: US 2009/0234997 A1
(43) Pub. Date: Sep. 17, 2009

(54) CONNECTING DEVICE FOR CONNECTING INDUSTRIAL APPARATUSES TO A COMMUNICATION BUS

(75) Inventor: MAURO MACCHI, MONZA (MILANO) (IT)

Correspondence Address: Pearne & Gordon LLP, 1801 East 9th Street, Suite 1200, Cleveland, OH, 44114-3108, US

(73) Assignee: YOUR VOICE S.P.A., MILANO (IT)

(21) Appl. No.: 12/047,000

(22) Filed: Mar. 12, 2008

(51) Int. Cl. G06F 13/42

(52) U.S. Cl. 710/106

(57) ABSTRACT

A connecting device for connecting industrial apparatuses to a communication bus, comprising: a first physical interface (10) for connection with a bus (60), in order to receive signals from/send signals to said bus; a second physical interface (20) for connection with an apparatus (2), in order to receive signals from/send signals to said apparatus (2); a processing unit (40) interposed between the first and second interfaces (10, 20); a third interface (30) associated with said processing unit (40) for receiving/sending wireless signals.

### FIELD AND BACKGROUND OF THE INVENTION

The invention relates to a connecting device for connecting industrial apparatuses to a communication bus.

The invention preferably applies in the industrial field, typically whenever a plurality of machines (for any type of working) are distributed inside the same structure and are connected to each other through a communication bus.

It is known that, above all in the industrial field, structures are presently used in which a plurality of machines are positioned within the same area (a shed or similar place, for example) and are connected to each other by means of a communication bus.

Through the same bus a communication with a control unit can also be obtained, which unit is entrusted with the task of dealing with operation of the machines associated therewith.

Within this technical field, the present invention aims at making available a connecting device for connecting industrial apparatuses to a communication bus which is able to improve communication between the different machines and between the machines and the control unit.

### SUMMARY OF THE INVENTION

In particular, it is an object of the present invention to provide a connecting device enabling the already present communication networks to become redundant.

Another object of the invention is to provide a connecting device suitable for application to already existing systems without particular modifications and adaptation operations being required.

It is a further object of the invention to make available a connecting device that is able to add new operating activities to the presently existing communication systems.

It is a still further object of the invention to provide a connecting device that is capable of adapting itself in a simple and quick manner to possible modifications made to the communication system with which the device itself is associated.

The foregoing and still further objects are substantially achieved by a connecting device for connecting industrial apparatuses to a communication bus, in accordance with the features recited in the appended claims.

### BRIEF DESCRIPTION OF THE DRAWINGS

Further features and advantages will be best understood from the detailed description of a preferred but not exclusive embodiment of the invention. This description is set out hereinafter with reference to the accompanying drawings, given by way of non-limiting example, in which:

FIG. 1 is a block diagram of a connecting device in accordance with the invention;

FIG. 2 is a block diagram of a communication system comprising the device shown in FIG. 1.

### DESCRIPTION OF THE PREFERRED EMBODIMENT

With reference to the drawings, a connecting device in accordance with the invention has been generally identified with 1.

Device 1 is used for connecting a respective industrial apparatus 2 to a communication bus 60.

Industrial apparatuses 2 may for instance comprise actuating members (such as motors, inverters, actuators, etc.), detecting devices (such as pressure sensors, temperature sensors, etc.), machinery, control devices, and so on.

Also included among apparatuses 2, 2a can be a control apparatus 2a designed to control operation of the remaining apparatuses 2 connected to bus 60.

By way of example, the control apparatus 2a can be a PLC, through which the control logic of the network consisting of apparatuses 2 is obtained.

The protocol used on bus 60 is preferably a so-called fieldbus and can be a modbus, profibus, etc. protocol, for example.

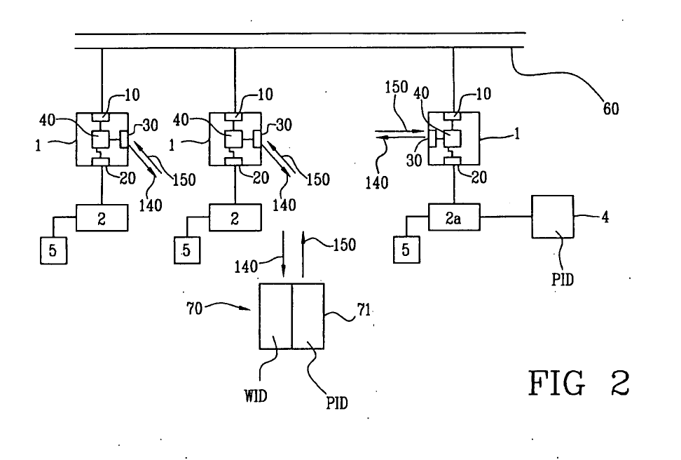

Each apparatus 2, 2a is connected to bus 60 by means of a respective device 1, as diagrammatically shown in FIG. 2.

The structure of each of the devices 1 employed in such a system will be now described.

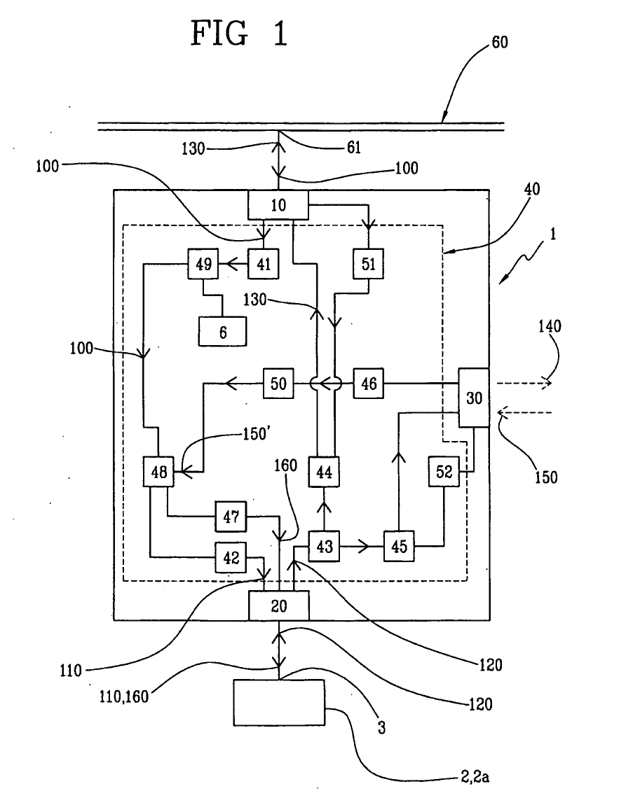

Device 1 (FIG. 1) comprises a first physical interface 10 for connection with bus 60; the first interface 10 enables device 1 to receive signals from bus 60, and/or to send signals to the bus 60 itself.

The first interface 10 is of the “physical” type, which means that, in order to enable a connection to be made with bus 60, the first interface 10 and bus 60 must be in contact with each other.

Practically, the first interface 10 defines a cabled connection with bus 60. In more detail, the first interface 10 is provided for engagement with a corresponding interface 61 of bus 60.

By way of example, the first interface 10 can be of the serial type (RS232, RS485), of the ethernet type, etc.

Device 1 further comprises a second physical interface 20, for connection with the respective apparatus 2, 2a.

The second interface enables device 1 to receive signals from apparatus 2, 2a, and/or to send signals to the apparatus 2, 2a itself.

Each apparatus 2, 2a is preferably provided with a control unit, entrusted with the task of dealing with the apparatus operation and allowing a communication with one or more of the other apparatuses at least through said bus 60.

Like the first interface 10, the second interface 20 too is of the “physical” type, which means that it defines a cabled connection between device 1 and the respective apparatus 2, 2a, of such a nature that device 1 and the respective apparatus 2, 2a must be substantially in contact with each other for enabling the second interface 20 to communicate with apparatus 2, 2a.

In more detail, the second interface 20 is provided for engagement with a respective interface 3 of apparatus 2, 2a. By way of example, the second interface 20 can be of the serial type (RS232, RS485), of the ethernet type, etc.

Preferably the first interface 10 is substantially equal to interface 3 of apparatus 2, 2a associated with device 1, and the second interface 20 is substantially equal to interface 61 of bus 60. This means that device 1 is connected to apparatus 2, 2a in the same manner as bus 60 can be connected to the apparatus 2, 2a itself. In other words, taking into account a system in which apparatus 2, 2a is directly connected to a bus 60 through a physical interface, it is possible to disconnect apparatus 2, 2a from bus 60, to connect apparatus 2, 2a to the second interface 20 of device 1, and finally to connect the first interface 10 of device 1 to the interface 61 of bus 60.

Device 1 further comprises a processing unit 40 interposed between the first and second interfaces 10, 20.

As it will become apparent from the following, the processing unit 40 allows a logical bypass between the first and second interfaces 10, 20 to be carried out, so that apparatus 2, 2a can communicate with bus 60 as if device 1 were not interposed and apparatus 2, 2a were directly connected to bus 60.

In more detail, the processing unit 40 comprises a first reception module 41 for receiving at least one main signal 100 from bus 60, through the first interface 10.

The processing unit 40 further comprises a first transmission module 42 for generating at least one corresponding auxiliary signal 110 to be sent to apparatus 2, 2a through the second interface 20.

The auxiliary signal 110 is substantially equal to the main signal 100, so that signals coming from bus 60 and received by device 1 are re-proposed in a substantially equal manner to apparatus 2, 2a.

It is to be noted that “equal signals” or “substantially equal signals” means signals having the same information contents, offered through the same protocol and according to the same electrical features, so that reception either of a given signal or of a signal equal thereto, is quite indifferent for a hypothetical device adapted to receive such signals.

The processing unit 40 further comprises a second reception module 43 for receiving at least one primary signal 120 from apparatus 2, 2a, through the second interface 20.

The processing unit 40 also comprises a second transmission module 44 for generating at least one corresponding secondary signal 130 to be sent to bus 60 through the first interface 10.

The secondary signal 130 is substantially equal to the primary signal 120.

In this manner device 1 allows a two-way communication between apparatus 1 and bus 60 which in a substantially identical manner reproduces the communication that would take place if apparatus 2, 2a were directly connected to bus 60.

It will be appreciated that connection between the first and second interfaces 10, 20 is not therefore made through a physical direct connection, but through the processing unit 40 receiving signals from the first interface 10 and generating substantially identical new signals, that will be then supplied to the second interface 20 so as to enable an actual communication to bus 60 of apparatus 2, 2a.

The same is true for data that from apparatus 2, 2a reach the second interface 20 to be then sent to the first interface 10 and therefrom to bus 60.

Device 1 in addition comprises a third interface 30 associated with the processing unit 40 to receive/send wireless signals.

By way of example, the third interface 30 can be provided with a Wi-Fi, Wi-Max, Zigbee, Bluetooth module, etc.

As will be better clarified in the following, the third interface 30 can be advantageously utilized to cause the communication system obtained through bus 60 to become redundant so that communication from and to apparatus 2, 2a is made more reliable.

Preferably the processing unit 40 further comprises an auxiliary transmission module 45 to send at least one first wireless signal 140, substantially having the same contents as said primary signal 120, through the third interface 30.

The second reception module 43 receives the primary signal 120, and is operatively active on the second transmission module 44 and on the auxiliary transmission module 45 to selectively cause generation of the secondary signal 130 and/or generation of the first wireless signal 140.

In a first operating condition, the second reception module 43 causes generation of both the secondary signal 130 and the first wireless signal 140; preferably the secondary signal 130 and the first wireless signal 140 have the same contents. In this case, the device 1 can be used to enable the communication network to become redundant.

In another operating condition, the second reception module 43 causes generation of the secondary signal 130 only, and does not cause generation of the first wireless signal 140.

In a further operating condition, the second reception module 43 causes generation of the first wireless signal 140, and does not cause generation of the secondary signal 130.

In a further operating condition, the second reception module 43 can cause the generation of either the first wireless signal 140, or the secondary signal 130, or both of them, or none of them, by analyzing the content of the primary signal 120 and applying any appropriate configured rule.

Therefore, according to the operating condition in which the second reception module 43 is set, the contents of a primary signal 120 can be re-transmitted through the first interface 10 (second signal 130) and/or through the third interface 30 (first wireless signal 140).

Preferably the second reception module 43 can be driven between the aforementioned operating conditions through a selection device (not shown) which can be actuated by a user, such as a dip switch, for example.

In addition or as an alternative, the second reception module 43 can be driven between the aforementioned operating conditions via software, by a proper digital command or instruction sent to the device 1, and in particular to the second reception module 43.

In a preferred embodiment, the digital command or instruction can be sent to the device 1 by means of a wireless technology, and in particular through the third interface 30.

Preferably, the processing unit 40 also comprises a third reception module 46 for receiving at least one second wireless signal 150, through the third interface 30.

In a preferred embodiment, the second wireless signal 150 has substantially the same contents as the main signal 100.

Preferably, the processing unit 40 also comprises a third transmission module 47 for generating a corresponding transmission signal 160 to be sent to apparatus 2, 2a through the second interface 20 and substantially having the same contents as the second wireless signal 150.

The third reception module 46 provides the third transmission module 47 or causes the third transmission module 47 to be provided with a cabled signal 150′ having the same contents as the second wireless signal 150.

In this manner, the same signals addressed to apparatus 2, 2a can be received both through physical connection and through wireless connection and, likewise, the signals generated by apparatus 2, 2a can be sent both through physical connection and through wireless connection.

Advantageously the processing unit 40 further comprises a selection module 48 active on the first transmission module 42 and on the third transmission module 47 to cause generation of the auxiliary signal 110 and/or of the transmission signal 160.

In case the device 1 is used to enable the network that apparatus 2, 2a belongs to become redundant, the contents of the main signal 100 and of the second wireless signal 150 can be the same; therefore the selection module 48 will be able to compare the contents of the main signal 100 and of the second wireless signal 150 and, in case such content is the same, generation of only one between the auxiliary signal 110 and transmission signal 160 will be caused.

It is to be noted that the contents taken into consideration by the selection module 48 may preferably comprise a unique identifier of the aforementioned signals; thus, in case the main signal 100 and second wireless signal 150 are associated with the same identifier (i.e. the main signal 100 and the second wireless signal 150 are “the same signal”, only transmitted in two different ways), the information contained in such signals may be sent to the apparatus 2, 2a only once (through the auxiliary signal 110 or the transmission signal 160).

According to a different operating condition, the selection module 48 takes into consideration the main signal 100 only and causes generation of the auxiliary signal 110 only; the second wireless signal 150 is not taken into consideration and the transmission signal 160 is not generated.

According to a further different operating condition, the selection module 48 takes into consideration the signal provided by the third reception module 46 and cause generation only of the transmission signal 160 only; the main signal 100 is not taken into consideration and the auxiliary signal 110 is not generated.

According to a further different operating condition, the selection module 48 takes into consideration both the main signal 100 and the signal 150′ provided by the third reception module 46, and causes generation of both the auxiliary signal 110 and of the transmission signal 160; no selection between the latter will be performed, and the contents of the received signals will not be taken into consideration.

In particular the main signal 100 may have different contents than the cabled signal 150′.

The selection module 48 can superimpose a semantic filter on the previously defined operating conditions by allowing or inhibiting the generation of the auxiliary signal 110 and/or the transmission signal 160 by analyzing the content of the primary signals 100 and/or signal 150′, and applying any appropriate configured rule.

The selection module 48 can be set up in one of the operating conditions described above by means of a selection device (not shown), which can be actuated by a user, such as for example a dip switch.

In addition or as an alternative, the selection module 48 can be set up in one of the operating conditions described above via software, by a proper digital command or instruction sent to the device 1, and in particular to the selection module 48.

In a preferred embodiment, the digital command or instruction can be sent to the device 1 by means of a wireless technology, and in particular through the third interface 30.

Preferably, the wireless signals sent/received by the third interface 30 are short range wireless signals.

It is to be noted that in the present context and in the following claims, the expression “short range” refers to wireless networks where technologies are used in which the maximum connection distance is geographically restricted and can be preferably included between some meters and some ten kilometers.

The short range wireless networks are not natively connected to each other and do not natively form remote connections. The short range wireless networks substantially are wireless LANs (Local Area Networks).

Therefore, a short range wireless signal will be a signal by which two devices linked to the same short range network communicate.

By way of example, with reference to the present invention, short range wireless networks of the Wi-Fi, Wi-Max, Zigbee, Bluetooth, etc. types can be utilized.

Preferably, for controlling wireless communication between apparatuses 2, 2a, use of a wireless router 70 is provided (FIG. 2).

Preferably, each device 1 is uniquely identified by a respective wireless identifier WID, i.e. a parameter enabling each device 1 to be detected within the wireless network.

Preferably, each apparatus 2, 2a is uniquely identified by a physical identifier PID, i.e. a parameter enabling each apparatus 2, 2a to be detected within the “physical” network consisting of apparatus 2, 2a and bus 60.

Said router 70 therefore can comprise a memory 71 into which the wireless identifiers WIDs of each device 1 are stored and in which each wireless identifier WID is associated with the physical identifier PID of apparatus 2, 2a connected to the device 1 detected by the respective wireless identifier WID.

In other words, the wireless router 70 allows the different apparatuses 2, 2a and devices 1 associated therewith to be detected within the wireless network.

In more detail, the control apparatus 2a, preferably consisting of a PLC, comprises a first storage register 4 (FIG. 2) containing the list of the physical identifiers PIDs of all apparatuses 2, i.e. the identifiers through which apparatuses 2 can be detected in the physical connection via bus 60.

In addition, each apparatus 2 is preferably provided with a second storage register 5 into which its own physical identifier PID is stored together with the physical identifier of the control apparatus 2a.

Preferably each device 1 is provided with a storage register 6 into which its own wireless identifier WID and the wireless identifier of router 70 are stored.

When the control apparatus 2a must send a signal (a control, command, setting, query signal, etc., for example) to another apparatus 2, the following steps are carried out:
the control apparatus 2a generates the primary signal 120 and, through its own second interface 20, its own first interface 10 and bus 60, sends the corresponding secondary signal 130, incorporating the physical identifier PID of the addressee apparatus; this identifier is suitably selected in the first storage register 4;
the control apparatus 2a, through the third interface 30 of device 1 associated therewith, sends a first wireless signal 140 addressed to router 70 (i.e. incorporating the wireless identifier of the router 70 itself), and comprising the physical identifier of the addressee apparatus 2, together with other data contained in the primary signal 120; practically, the first wireless signal 140 contains the same information as contained in the primary signal 120, to which the wireless identifier WID of the wireless router 70 is added;
device 1 associated with the addressee apparatus 2 receives a main signal 100 (i.e. the secondary signal transmitted from the control apparatus 2a) through its own first interface 10, and sends the corresponding auxiliary signal 110 to the addressee apparatus 2, through the second interface 20;
router 70 receives the first wireless signal 140 transmitted by the control apparatus 2a; note that all devices 1 of the other apparatuses 2 will “hear” such a wireless signal but will interpret it as a signal not addressed to themselves, since they do not recognize the addressee wireless identifier WID incorporated therein;
router 70 retrieves, in its own memory, the wireless identifier WID of device 1 associated with the addressee apparatus 2 detected by the wireless signal received (it is to be remembered that the wireless signal received incorporates, among other data, the physical identifier PID of the addressee apparatus 2);
router 70 generates a new wireless signal, referred to as second wireless signal 150, incorporating the wireless identifier WID of the device 1 associated with the addressee apparatus 2;
device 1 associated with the addressee apparatus 2 receives, through its own third interface 30, the second wireless signal 150 generated by router 70 and addressed to said apparatus 2; device 1 is able to establish that it is the addressee of such a signal 150 because it knows its own wireless identifier and compares it with the wireless identifier incorporated into the signal from router 70;
the second wireless signal 150 received by device 1 associated with the addressee apparatus 2 is then sent to the addressee apparatus 2 through the second interface 20.

In a quite dual manner, when apparatus 2 must send a signal to the control apparatus 2a the following steps are performed:
generating and transmitting a physical signal by the sender apparatus 2 through bus 60; this signal incorporates the physical identifier PID of the control apparatus 2a; by way of example, the signal generated by the sending apparatus 2 can be a detection signal, an alarm signal, a notification signal, an asynchronous notification signal, etc.;
wireless repeating this physical signal and sending it through the third interface of device 1 associated with the sender apparatus 2;
receiving the physical signal by the control apparatus 2a through bus 60 and the first and second interfaces 10, 20 of the device 1 associated with the control apparatus 2a;
receiving by router 70, the wireless signal generated by the device 1 associated with the sender apparatus 2;
selecting by router 70, the wireless identifier of the device 1 associated with the control apparatus 2a, and sending a wireless signal substantially having the same contents as the received signal;
receiving by the device 1 associated with the control apparatus 2a, the wireless signal generated by router 70 and sending the contents of this signal to the control apparatus 2a, by the device 1 itself.

It should be appreciated that the above described sequence of steps is carried out in case the device 1 is used to enable the communication network to become redundant.

Should the device 1 be used for different purposes than redundancy (see different operating conditions of the selection module 48 and/or of the second reception module 43), only some of such steps will be performed.

Advantageously, the processing unit 40 can be provided with a first identification module 49 for detecting in the main signal 100 received, a parameter representative of the fact that such a main signal 100 is to be sent to apparatus 2, 2a associated with said device 1.

This parameter can be the above mentioned physical identifier PID of apparatus 2, 2a associated with device 1.

It is to be pointed out that this identification step can be carried out both in an independent manner by apparatus 2 (therefore without the device 1 being provided with the first identification module), and by the processing unit 40 through said first identification module 49.

At all events, device 1 and/or apparatus 2 associated therewith are provided with a suitable storage register in which the physical identifier of this apparatus 2 is stored, so that the recognition step can be correctly performed.

Advantageously, the processing unit 40 can be provided with a second identification module 50 to detect in the second wireless signal 150 received, a parameter representative of the fact that its signal is to be sent to the apparatus associated with the device 1 in question.

Preferably, this parameter is the above mentioned wireless identifier WID of device 1.

In this connection, device 1 (and in particular the processing unit 40) can be conveniently provided with a storage register in which the wireless identifier thereof is stored, so as to suitably perform the mentioned recognition step.

In a preferred embodiment, the processing unit 40 further comprises a first control module 51 to control whether the first interface 10 is connected to the corresponding interface 61 of bus 60.

The control carried out by the first control module 51 can be of the periodical type or also of a substantially continuous type.

This control aims at avoiding the first interface 10 being taken into account for sending signals (secondary signal 130) and/or receiving signals (main signal 100), so as to save the device 1 resources in terms of electric power and computational activity.

Advantageously, the processing unit 40 may further comprise a second control module 52 to control whether the third interface 30 is connected to a corresponding wireless network for receiving/transmitting wireless signals.

The control carried out by the second control module 52 can be of the periodical type or also of a substantially continuous type.

This control aims at avoiding the third interface 30 being taken into account for sending signals (first wireless signal 140) and/or receiving signals (second wireless signal 150), so as to save the device 1 resources in terms of electric power and computational activity.

The first and/or third interface 10, 30 can therefore be monitored, and possibly excluded from the sending/receiving operations; monitoring preferably goes on also when one or both interfaces 10, 30 are deactivated, so that as soon as an interface becomes ready for use again (i.e. the first interface 10 is physically connected to a bus 60 and/or the third interface 30 is linked to a wireless network), the same interface is utilized again for sending signals and being inquired for possible receptions.

In a further embodiment, in addition or as an alternative to the different devices 1, the network formed by apparatuses 2, 2a and bus 60 can be provided with an auxiliary device having a physical interface through which it is connected to bus 60 and a wireless interface for long range wireless connection.

It is to be pointed out that in the present context the expression “long range” refers to wireless networks where technologies are used in which the maximum connection distance is geographically substantially boundless.

The long range wireless networks can be connected to each other for natively obtaining remote connections.

The long range wireless networks are substantially wireless WANs (Wide Area Networks).

Therefore, a long range wireless connection will be obtained through signals enabling a communication between two devices linked to the same long range network and positioned without any considerable limitation in their mutual distance.

For instance, the wireless interface of said auxiliary device may comprise a GPRS module, a UMTS module, etc.

Therefore through the auxiliary device it is possible to carry out a remote control of the whole operation of the network formed by apparatuses 2, 2a and bus 60 and to supply all related information to a remote management unit.

Practically, the auxiliary device, due to the connection allowed by its first interface, is “seen” by apparatuses 2, 2a as a further apparatus connected to bus 60.

The auxiliary device however will have a different functional character, not of the operating type like the other apparatuses 2, 2a, but of the “connective” type to carry out the above described long range connectivity.

It is to be noted that should a short range wireless network be present, for connection between apparatuses 2, 2a, the auxiliary device could be provided with a first wireless interface for a short range connection with the wireless network of which also devices 1 associated with apparatuses 2, 2a are part, in combination with said second interface for long range wireless connections.

Please note that processing unit 40 included in device 1 has been disclosed as comprising a plurality of separate modules only for sake of clarity and for properly describe the functions that the same processing unit 40 can carry out.

Such modules are not necessarily to be considered as separate hardware modules.

Such modules can be realized as software modules, adapted to perform the above described functions when loaded in the processing unit 40, so that the same processing unit can be realized as a single electronic device.

The invention achieves important advantages.

First of all, through the device of the invention communication between the different apparatuses, and in particular between the slave apparatuses and the control apparatus, is greatly improved.

In addition, due to the fact that the communication can be made redundant through the device of the invention, safety and reliability of the network are increased.

Another advantage is found in the fact that the device being the object of the invention can be applied to already existing systems without particular modifications and adaptation operations being required.

Another advantage consists in that, should the whole system be submitted to modifications (of structural character for example, in terms of variation in the apparatus arrangement, etc.) the device of the invention is perfectly able to adapt itself without any particular adaptation operation being required.

What is claimed is:

1. A connecting device for connecting industrial apparatuses to a communication bus, comprising:
a first physical interface (10) for connection with a bus (60), for receiving signals from/sending signals to said bus;
a second physical interface (20) for connection with an apparatus (2), for receiving signals from/sending signals to said apparatus (2);
a processing unit (40) interposed between the first and second interfaces (10, 20);
a third interface (30) associated with said processing unit (40) for receiving/sending wireless signals.

2. The device as claimed in claim 1, wherein the first interface (10) is designed to be associated with a corresponding interface (61) of said bus (60),
said second interface (20) being designed to be associated with a corresponding interface (3) of said apparatus (2),
said first interface (10) being substantially equal to the interface (3) of said apparatus (2),
said second interface (20) being substantially equal to the interface (61) of said bus (60).

3. The device as claimed in claim 1, wherein said processing unit (40) comprises:
a first reception module (41) for receiving at least one main signal (100) from said bus (60), through said first interface (10);
a first transmission module (42) for generating at least one corresponding auxiliary signal (110) to be sent to said apparatus (2) through said second interface (20), said auxiliary signal (110) being substantially equal to said main signal (100).

4. The device as claimed in claim 1, wherein said processing unit (40) comprises:
a second reception module (43) for receiving at least one primary signal (120) from said apparatus (2), through said second interface (20);
a second transmission module (44) for generating at least one corresponding secondary signal (130) to be sent to said bus (60) through said first interface (10), said secondary signal (130) being substantially equal to said primary signal (120).

5. The device as claimed in claim 4, wherein said processing unit (40) further comprises an auxiliary transmission module (45) for sending at least one first wireless signal (140) through said third interface (30), which first wireless signal substantially has the same contents as said primary signal (120).

6. The device as claimed in claim 5 wherein said second reception module (43) is active on said second transmission module (44) and said auxiliary transmission module (45) to cause generation of said secondary signal (130) and/or of said first wireless signal (140).

7. The device as claimed in claim 3, wherein said processing unit (40) further comprises:
a third reception module (46) for receiving at least one second wireless signal (150) through said third interface (30);
a third transmission module (47) for generating a corresponding transmission signal (160) to be sent to said apparatus (2) through said second interface (20) and substantially having the same contents as said second wireless signal (150).

8. The device as claimed in claim 7, wherein said second wireless signal (150) substantially has the same contents as said main signal (100).

9. The device as claimed in claim 7, wherein said processing unit (40) further comprises a selection module (48) operatively active on said first transmission module (42) and said third transmission module (47) for causing generation of said auxiliary signal (110) and/or of said transmission signal (160).

10. The device as claimed in claim 1, wherein said wireless signals are short range wireless signals.

11. The device as claimed in claim 1, wherein said wireless signals are sent to/transmitted from a wireless router (70), designed to control wireless communications between two or more of said apparatuses (2).

12. The device as claimed in claim 3, wherein said processing unit (10) is provided with a first identification module (49) for detecting in said main signal (100), a parameter representative of the fact that said main signal (100) is intended for said apparatus (2).

13. The device as claimed in claim 7, wherein said processing unit (40) is provided with a second identification module (50) for detecting in said second wireless signal (150), a parameter representative of the fact that said second wireless signal (150) is intended for said apparatus (2).

14. The device as claimed in claim 2, wherein said processing unit (40) further comprises a first control module (51) for controlling whether said first interface (10) is connected to the corresponding interface (61) of said bus (60).

15. The device as claimed in claim 2 wherein said processing unit (40) further comprises a second control module (52) for controlling whether said third interface (30) is connected to a corresponding wireless network for receiving/transmitting said wireless signals.

16. A connecting network comprising:
a communication bus (60) for mutually connecting two or more apparatuses (2);
a plurality of connecting devices (1) as claimed in claim 1, each interposed between said bus (60) and a respective one of apparatuses (2).

17. The network as claimed in claim 15, further comprising a wireless router (70) designed to deal with wireless communications between two or more of said apparatuses (2) through the respective connecting devices (1).

18. The network as claimed in claim 17, wherein each of said devices (1) is uniquely identified by a respective wireless identifier (WID),
each apparatus (2) being uniquely identified by a physical identifier (PID),
said router (70) comprising a memory (71) into which the wireless identifier (WID) of each of said devices (1) are stored, each wireless identifier (WID) being associated in said memory (71) with the physical identifier (PID) of the apparatus (2) connected to the device (1) detected by said wireless identifier (WID).

19. A system for communication between industrial apparatuses, comprising:
a plurality of industrial apparatuses (2), said plurality of apparatuses comprising at least one control apparatus (2a) designed to deal with the remaining apparatuses (2);
a bus (60) for connecting said apparatuses (2) to said control apparatus (2a);
a plurality of devices (1) as claimed in claim 1, each interposed between said bus (60) and a respective one of said apparatuses (2, 2a);
a wireless router (70) designed to deal with wireless communications between said control apparatus (2a) and the remaining apparatuses (2) through the respective connecting devices.
